(19) United States
(12) Patent Application Publication
(10) Pub. No.: US 2008/0128665 A1
(43) Pub. Date: Jun. 5, 2008

(54) NANOPARTICLE BASED THIN FILMS

(75) Inventors: Junjun Wu, Woodbury, MN (US); John E. Potts, Woodbury, MN (US); Jung-Sheng Wu, Woodbury, MN (US); James E. Thorson, Hudson, WI (US)

Correspondence Address: 3M INNOVATIVE PROPERTIES COMPANY, PO BOX 33427, ST. PAUL, MN, 55133-3427, US

(73) Assignee: 3M Innovative Properties Company

(21) Appl. No.: 11/566,523

(22) Filed: Dec. 4, 2006

(51) Int. Cl. H01B 1/02

(52) U.S. Cl. 252/518.1; 106/316; 252/500; 977/811

(57) ABSTRACT

A nanoparticle thin film is described. An article includes a substrate and the nanoparticle thin film that includes nanoparticles having an average size from 5 nm to 50 nm, at least one electroactive chemical, and at least one organic binder material. The electroactive chemical binds to the surface of the nanoparticles. Also described are dispersions and coating compositions.

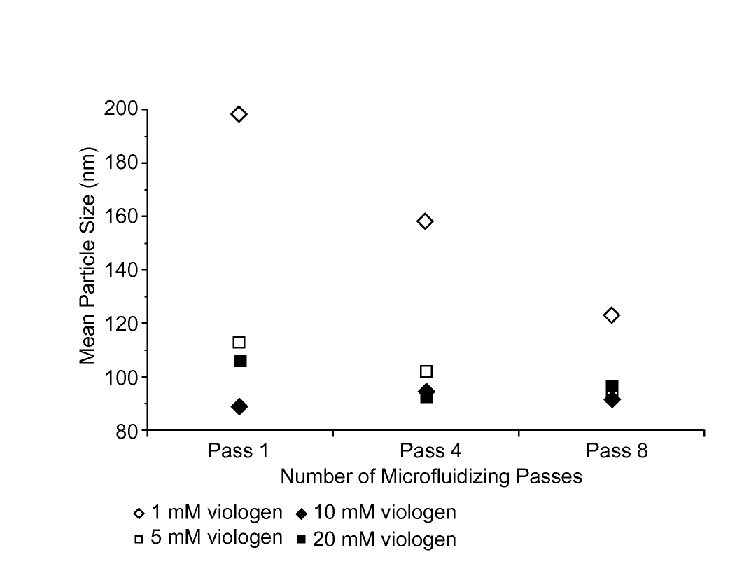

### BACKGROUND

The invention relates to nanoparticle dispersions, nanoparticle containing coating compositions and methods of using both.

Nanoparticle based films can be useful in many electrochemical applications, examples of which include electrochromic devices, batteries, and solar cells. In order to control and fine tune such devices that include nanoparticle based films, it can be desirable to form uniform films. Currently utilized methods do not necessarily provide films with these characteristics, often lack the ability to precisely control the film composition and thickness, are difficult to produce films on a large scale, and are generally not amenable to low temperature processing. Therefore, there remains a need for methods of producing such films, components for producing the films, and the films produced thereby.

### BRIEF SUMMARY

Described is a dispersion that includes nanoparticles having an average diameter from 5 nm to 50 nm; and at least one electroactive chemical wherein the electroactive chemical binds to the surface of the nanoparticles, the dispersion includes agglomerates of the electroactive chemical bound nanoparticles, and a majority of the agglomerates have an average diameter that is not greater than 1 micrometer.

Described is a coating composition that includes a dispersion having nanoparticles having an average diameter from 5 nm to 50 nm; and at least one electroactive chemical wherein the electroactive chemical binds to the surface of the nanoparticles, the dispersion includes agglomerates of the electroactive chemical bound nanoparticles, and a majority of the agglomerates have an average diameter that is not greater than 1 micrometer at least one organic binder material; and at least one solvent, wherein the coating composition has a viscosity of less than 100 Pa·sec.

Described is an article that includes a substrate; and a nanoparticle thin film that includes nanoparticles having an average size from 5 nm to 50 nm; and at least one electroactive chemical, wherein the electroactive chemical binds to the surface of the nanoparticles; and at least one organic binder material.

### BRIEF DESCRIPTION OF THE DRAWINGS

The sole FIGURE shows measured TiO₂ particle size as a function of the number of microfluidizer passes at different viologen concentrations in the dispersions.

### DETAILED DESCRIPTION

As used herein, “average diameter” refers to the average nominal diameter of the nanoparticles. Instances where particles with at least two average diameters are utilized, refers to the use of two separate particle compositions having at least two different average diameters.

Unless otherwise indicated, all numbers expressing feature sizes, amounts, and physical properties used in the specification and claims are to be understood as being modified in all instances by the term “about.” Accordingly, unless indicated to the contrary, the numerical parameters set forth in the foregoing specification and attached claims are approximations that can vary depending upon the desired properties sought to be obtained by those skilled in the art utilizing the teachings disclosed herein.

The recitation of numerical ranges by endpoints includes all numbers subsumed within that range (e.g. 1 to 5 includes 1, 1.5, 2, 2.75, 3, 3.80, 4, and 5) and any range within that range.

As used in this specification and the appended claims, the singular forms “a”, “an”, and “the” include plural referents unless the content clearly dictates otherwise. Thus, for example, reference to a composition containing “a nanoparticle layer” includes two or more nanoparticle layers.

One embodiment includes a dispersion having nanoparticles and at least one electroactive chemical. In a dispersion, the electroactive chemical binds to the surface of the nanoparticles. Dispersions have a majority of agglomerates that have a diameter in the submicron range.

Dispersions utilized herein include nanoparticles. In one embodiment, any nanoparticle that can function to provide reversible electron transport through a structure of the nanoparticles can be utilized. In one embodiment, nanoparticles can be chosen based on at least two competing, but desirable, characteristics of a final layer that can be created with the dispersion; the porosity of the layer and the surface area per unit geometrical area of the particle layer. For example, in an instance where the electrode will ultimately be used in an electrochromic device, the porosity and the pore size of the layer contributes to the switching speed by permitting passage of the mobile ionic components in the electrolyte, and the surface area contributes to the contrast. It is generally desirable to have an electrochromic device that has a high contrast ratio. This provides a display that has a strong, vivid color (when the electroactive chemical is in one oxidation state) in comparison to the white or off white non-color (when the electroactive chemical is in the other oxidation state). It is also generally desirable to have an electrochromic display that has a fast switching speed from one color to another; generally from white (when a white background is used) to a color and vice versa (the switch from colored to white state can also be referred to as bleaching). With respect to nanoparticles that are utilized in dispersions, generally, the use of smaller diameter particles will provide a larger surface area that may ultimately provide a higher contrast ratio. In contradiction to that, the use of larger particles will provide a layer having larger average pore size, which may ultimately provide faster switching speeds by providing easy access to the ions in the electrolyte. These two opposing characteristics also play a role, albeit with different manifestations, in other applications.

Nanoparticles that are useful include semiconductive or conductive nanoparticles. Exemplary nanoparticles that can be utilized can be represented by the following general formula: MₐX_{b} wherein M is a metal atom, including but not limited to, zinc (Zn), cadmium (Cd), mercury (Hg), indium (In), gallium (Ga), titanium (Ti), tungsten (W), lead (Pb), zirconium (Zr), vanadium (Va), niobium (Nb), tantalum (Ta), silver (Ag), cerium (Ce), strontium (Sr), iron (Fe²⁺ or Fe³⁺) nickel (Ni) or a perovskite thereof; and X can include, but is not limited to, oxygen (O), sulfur (S), selenium (Se), tellurium (Te), phosphorus (P), arsenic (As), and nitrogen (N); and a and b are stochiometric numbers. Mixtures of metal atoms may also be utilized as nanoparticles.

Specific examples of nanoparticles that can be utilized include, but are not limited to zinc oxide (ZnO), zinc sulfide (ZnS), zinc selenide (ZnSe), zinc tellurium (ZnTe), cadmium oxide (CdO), cadmium sulfide (CdS), cadmium selenide (CdSe), cadmium tellurium (CdTe), mercury sulfide (HgS), mercury selenide (HgSe), mercury tellurium (HgTe), indium phosphide (InP), indium arsenide (InAs), gallium nitride (GaN), gallium phosphide (GaP), gallium arsenide (GaAs), titanium dioxide (TiO₂), tungsten trioxide (WO₃), antimony oxide (SbO), tin oxide (SnO), lead sulfide (PbS), and lead selenide (PbSe). In one embodiment metal oxides represented as MOₓ, wherein M is as defined above, and x is an integer from 1 to 3, are utilized. In another embodiment titanium dioxide (TiO₂) is utilized as the nanoparticle.

Nanoparticles that are useful generally have an average diameter that is from 5 nanometers (nm) to 50 nm. In one embodiment, from 5 nm to 30 nm. In one embodiment, from 7 nm to 21 nm. In one embodiment where the nanoparticles are TiO₂, a commercially available nanoparticle with an average diameter of 21 nm is P25, available from Degussa AG (Dusseldorf, Germany). In one embodiment, nanoparticles with an average diameter of 7 nm are utilized. In one embodiment where the nanoparticles are TiO₂, a commercially available nanoparticle with an average diameter of 7 nm is ST-01, available from Ishihara Corporation USA (San Francisco, Calif.). In yet another embodiment, nanoparticles with two different average diameters are utilized in one dispersion. In yet a further embodiment, particles with an average diameter of 7 nm and particles with an average diameter of 21 nm are utilized. In one embodiment where the nanoparticles are TiO₂ nanoparticles, a commercially available nanoparticle with an average diameter of 7 nm, referred to as ST-01 and a commercially available nanoparticle with an average diameter of 20 nm, referred to as ST-21 are available from Ishihara Corporation (USA) (San Francisco, Calif.).

Generally, smaller nanoparticles will provide larger specific surface area than will larger nanoparticles. The specific surface area of a particle is the total surface area per volume or weight of a solid. Specific surface areas are reported herein as square meter per gram (m²/g). Generally, nanoparticles that can be utilized have a specific surface area of at least 20 m²/g. In one embodiment, nanoparticles that can be utilized have a specific surface area of at least 50 m²/g. In another embodiment nanoparticles that can be utilized have a specific surface area of 50 m²/g to 300 m²/g. Some embodiments will include the use of two different diameter nanoparticles that have specific surface areas of 50 m²/g and 300 m²/g respectively.

As mentioned above, as smaller diameter nanoparticles are used in a dispersion, the specific surface area of the nanoparticles increases, and for example, the contrast ratio of an electrochromic display that is fabricated using that dispersion can be higher than an electrochromic display that is fabricated using a dispersion with lower specific surface area particles (assuming the layer thicknesses are the same). Also, as smaller diameter nanoparticles are used in a dispersion, the pore size of the channels within a layer that is formed using that dispersion decreases. The channels permit the movement of ions through the electrolyte during device operation. For example, an electrochromic display that includes such a layer can have a slower switching speed than an electrochromic display that is fabricated using a dispersion with larger diameter nanoparticles. As seen here, these two exemplary desirable properties of an electrochromic display have to be weighed against each other when determining the size of the nanoparticle that is to be used when fabricating a device using a dispersion.

In an embodiment where nanoparticles having two different average diameters are utilized, the ratio of the amounts of the two particles is chosen based on the consideration of two different properties of the final film or device (contrast vs. switching speeds). Larger ratios (or amounts) of larger particles will increase the average pore size of a final layer, but will decrease the specific surface area of the particles which decreases the amount of electroactive chemical bound to the particles. Conversely, larger ratios (or amounts) of smaller particles will decrease the average pore size of a final layer, but will increase the specific surface area of the particles which increases the amount of electroactive chemical bound to the particles. In an embodiment where the dispersion will be used to create a film or layer that is used in an electrochromic device, larger amounts of larger particles will therefore increase the switching speed, and decrease the contrast ratio; and larger amounts of smaller particles will therefore decrease the switching speed, and increase the contrast ratio.

Generally dispersions utilized herein include nanoparticles in an amount that is capable of providing layers or coatings with desired properties. It will be understood by one of skill in the art, having read this specification that the amount of nanoparticles present in a dispersion can depend, at least in part, on the particle size of the nanoparticles. For example, if smaller particles, i.e. particles having a greater specific surface area are utilized, a smaller weight percent of the nanoparticles can be utilized in a dispersion.

In one embodiment, a dispersion includes not more than 50 wt-% of nanoparticles. In another embodiment, a dispersion includes not more than 40 wt-% of nanoparticles. In one embodiment the nanoparticles are present in an amount from 30 to 40 wt-% of the dispersion.

Dispersions utilized herein also include electroactive chemicals. Electroactive chemicals include chemicals that can be used as the active species in electrochemical devices such as photovoltaic cells, electrochromic displays and batteries.

When used in a dispersion, a suitable electroactive chemical should be capable of binding to the surface of the nanoparticle. This binding can be based on the particular structure of the electroactive chemical, the atomic structure of the nanoparticle, the nanostructure of the nanoparticle agglomerates, a surface treatment that is applied to the nanoparticle, or some combination thereof. In one embodiment, the surface of the nanoparticles is capable of binding the electroactive chemical due to a functional portion of the electroactive chemical. For example, the surface of the nanoparticles can be capable of binding an electroactive chemical that includes a specific chemical group. Exemplary chemical groups that can be included in electroactive chemicals include, but are not limited to, phosphonate groups, carboxylate groups, and sulfonate groups. Such exemplary groups can bind to Ti⁺⁴ sites on the TiO₂ nanoparticle surfaces. In such an embodiment, both charge interaction and chemical bonding may be taking place between the TiO₂ particles and the electroactive chemicals. In one embodiment, electroactive chemicals that include phosphonate groups are utilized.

Electroactive compounds which may be utilized in dispersions include, but are not limited to photosensitizers, electrochromophores, other redox species, and electroluminescent molecules.

Exemplary electroactive chemicals for use in forming dispersions to fabricate electrochromic devices include, but are not limited to ruthenium (II) complexes, polyanilines, polypyridyl complexes, viologen, and derivatives thereof. Exemplary electroactive chemicals for use in electrochromic devices also include those disclosed and exemplified in U.S. Pat. Nos. 4,841,021; and 4,898,923, the disclosures of which are incorporated herein by reference.

In an embodiment where the dispersion can be used to fabricate an electrochromic device, one possible electroactive chemical includes viologen or derivatives thereof. Further information regarding viologen can be found in: The Viologens, Physicochemical Properties, Synthesis and Applications of the Salts of 4,4′-Bipyridine”, Author: P. M. S. Monk, Publisher: John Wiley & Sons, 1998. Viologen, as referred to herein includes viologen and derivates thereof and can be represented by Formula I below:

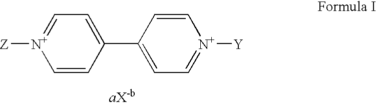

wherein at least one of Z and Y has a functional group that can bind to a surface of a nanoparticle in the dispersion;
a is 1 or 2; and
b is 1 or 2, with the proviso that aX^{-b} balances the charge of the two N⁺ in the rings.

In one embodiment, Z and Y independently contain a phosphonate group, a carboxylate group, or a sulfonate group. In one embodiment, X is chloride, fluoride, iodide, or bromide; a is 2; and b is 1.

One specific example of a modified viologen that can be utilized in a dispersion includes 1,1′-bis(2-phosphonoethyl)-4,4′-bipyridinium dichloride, the structure of which is given below.

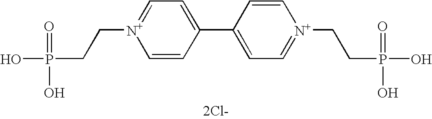

It is thought, but not relied upon, that, in a dispersion that utilizes a modified viologen (as exemplified above) and TiO₂ nanoparticles, the strong interaction between the phosphonate groups of the viologen and the TiO₂ surface binds the viologen molecules covalently to the surface of the TiO₂ nanoparticles.

Exemplary photosensitizers that can be used as electroactive chemicals in dispersions that can be utilized to form solar cells, include but are not limited to, the family of ruthenium(II) complexes widely used in dye sensitized solar cells (DSSC); such as bis(2,2′-bipyridine)(2,2′-bipyridine-4,4′-dicarboxylic acid)ruthenium(II) complex, other metal-containing dyes such as, for example, cis-bis(isothiocyanato)bis(2,2′-bipyridyl-4,4′-dicarboxylato)-ruthenium(II) (“N3 dye”); tris(isothiocyanato)-ruthenium(II)-2,2′:6′,2′-terpyridine-4,4′, 4′-tricarboxylic acid; cis-bis(isothiocyanato)bis(2,2′-bipyridyl-4,4′-dicarboxylato)-ruthenium(II) bis-tetrabutylammonium; cis-bis(isocyanato) (2,2′-bipyridyl-4,4′ dicarboxylato) ruthenium (II); and tris(2,2′-bipyridyl-4,4′-dicarboxylato) ruthenium (II) dichloride; anthocyanins, porphyrins, phthalocyanines, merocyanines, cyanines, squarates, eosins (most are commercially available from Solaronix, Switzerland). Other photosensitizing dyes including those with appropriate anchoring groups that can bind to the surface of the nanoparticles can also be utilized.

Generally, the amount of the electroactive chemical that is in a dispersion is at least partially dependent on the surface area of the nanoparticle in the dispersion because the electroactive chemical binds to the surface of the nanoparticle. Therefore, the more overall nanoparticle surface area there is in a dispersion, either due to the amount of nanoparticles in the dispersion or the size of the nanoparticles, the more electroactive chemical that can bind to the surface of the nanoparticles. Conversely, once enough electroactive chemical is provided in the dispersion to bind to all of the active portions of the surface of the nanoparticles, any excess electroactive chemical will participate in the equilibrium that will develop between the electroactive chemical in solution and that which is bound to the surface of the nanoparticle. One of skill in the art, having read this specification will also understand that the equilibrium that is established between the bound and free electroactive chemical can be affected by the pH and or ionic strength of the solution.

Generally, the electroactive chemical is utilized in solution. In one embodiment, the electroactive chemical is an aqueous solution when it is mixed with the nanoparticles. Other polar solvents, such as methanol, ethanol, methoxy-2-propanol, or mixtures thereof can also be utilized. In one embodiment, the pH, or ionic strength of the solution can be modified before the solution is mixed with the nanoparticles.

In one embodiment, the electroactive chemical can be present from 1 millimolar (mM) to 100 mM. In another embodiment, the electroactive chemical can be present from 10 mM to 100 mM. In another embodiment, the electroactive chemical can be present from 20 mM to 75 mM. In yet another embodiment, the electroactive chemical can be present from 20 mM to 50 mM when combined in a solution having P25 TiO₂ at 30 wt-% to 40 wt-%.

Dispersions that are utilized will include agglomerates. Agglomerates form when two or more particles bind together during and/or after particle synthesis either through van der Waals forces, chemical bonding, or a combination thereof. Agglomerates in the dispersion will have different, non-uniform diameters. Generally, dispersions that can be utilized have a majority of agglomerates that have submicron average diameters. Often, dispersions that can be utilized will have a bimodal or monomodal distribution of the diameter of agglomerates. However, regardless of the distribution, dispersions that are utilized have more agglomerates that have a submicron diameter than those with larger diameters. In one embodiment, a dispersion that can be utilized includes a majority of agglomerates that have an average diameter that is not greater than 1 μm. In one embodiment, a dispersion that can be utilized includes a majority of agglomerates that have an average diameter that is not greater than 500 nm. In another embodiment, a dispersion that can be utilized includes a majority of agglomerates that have an average diameter that is not greater than 100 nm.

Generally, dispersions with smaller agglomerate sizes tend to form layers that have more controlled and/or reproducible structures. More specifically, dispersions with smaller agglomerate sizes can tend to form layers that have a more controlled porosity, perhaps not a higher porosity, but more reproducible. Dispersions with smaller agglomerate sizes and narrower size distribution also tend to form layers with less surface roughness. Porosity of a layer can be important in instances where the layers are to be part of an electrochromic device for example, because porosity and pore size contribute to a fast and/or reproducible switching speed of the final electrochromic device. Solutions with smaller agglomerate size can also tend to form layers that have a more constant surface coverage of electroactive chemical. Otherwise, the internal surface in large agglomerates is not accessible to electroactive chemicals, thus resulting in lower surface coverage. Surface coverage of electroactive chemical can be important because high surface coverage of viologen, for example can also contribute to the switching speed of a final electrochromic device. Smaller agglomerate sizes can also contribute to reproducibly being able to control the thickness of the layers that are formed with the solution. In one embodiment, this can contribute to creating an electrochromic device with a good contrast ratio.

Agglomerate size of a solution can be determined as is well known to those of skill in the art. However, one exemplary method of determining agglomerate size includes use of a Diffraction Particle Size Analyzer, such as a LA-910 Laser Scattering Particle Size Distribution Analyzer (Horiba Instruments, Inc., Irvine, Calif.).

In one embodiment a dispersion is formed by initially mixing the nanoparticles with a solution containing the electroactive chemical and then dispersing the mixture by high shear force or attrition. One of skill in the art will understand that the mixing and dispersing step can be carried out in one step or in multiple steps. During these steps, the electroactive chemical binds to the surface of the nanoparticles. The resultant solution or dispersion has an agglomerate size that is in the submicron range, as discussed above.

The initial mixing step can be accomplished using any method known to those of skill in the art, including but not limited to, the use of a mixing device. The function of the initial mixing step is to create a dispersion that is flowable on a large scale and reduce the large agglomerates for further processes. One of skill in the art, having read this specification, will also understand that the initial mixing step can be eliminated and the step of dispersing the materials in the dispersion can function to create a homogenous solution.

After the initial mixing of the nanoparticles with the solution containing the electroactive chemicals, the mixture is dispersed. Generally, the function of the dispersing step is to form a dispersed solution, a dispersion, including a majority of agglomerates with a submicron diameter. Any method that can produce such a solution from the starting materials can be utilized herein. Generally, solutions containing nanoparticles with diameters of less than 20 nm will form solutions that have a majority of agglomerate sizes that are greater than submicron if a dispersion step is not utilized. The dispersion step can be accomplished using any method known to those of skill in the art, including but not limited to, the use of a microfluidizer® (Microfluidics Corp. Newton, Mass. for example), homogenizer (Gaulin 15 MR-8TA homogenizer from APV Gaulin, Minneapolis, Minn., for example), media mill (MiniCer from Netzsch Incorporated, Exton, Pa. for example), high shear mixing (Ulta-Turrax mixer from IKA Works, Inc. Wilmington Del., for example), or ultrasonicator (Misonix, Farmingdale, N.Y. or VirSonic Ultrasonic, VirTis—an SP Industries Company, Gardiner N.Y. for example).

In one embodiment, the dispersing step is accomplished by using a microfluidizer® from Microfluidics (Newton, Mass.) with serial 250 μm and 85 μm interaction chambers operated at about 10,000 to 30,000 psi for up to 8 to 16 passes. The final agglomerate size and size distribution can be easily controlled by either adjusting the pressure or the number of passes.

It should be noted that electroactive chemical bound nanoparticle dispersions can be used to form films or layers of nanoparticle/electroactive chemical without further processing. For example, it is not necessary to isolate the agglomerates, dry them, and redissolve them in order to use them in the fabrication of films or layers. It is thought, but not relied upon that this extra processing step is not necessary because the agglomerate size in the dispersion is controlled. Elimination of further processing steps can offer an advantage in process time, efficiency and economics.

Once a dispersion is prepared, it is generally a stable solution. As used herein, a stable solution refers to a solution that does not have particles falling out of solution (precipitating), or creating a two phase solution. Solutions that are stable also have agglomerates that remain suspended in solution. A stable solution also does not change viscosity during non-use or storage. As used herein, a stable solution does not refer to any electrical properties of the electroactive chemical. Generally, dispersions are stable for at least one day. In another embodiment, dispersions are stable for at least one week. In another embodiment, dispersions are stable for at least one month or longer.

Dispersions can be utilized to form films or layers that include the nanoparticle/electroactive chemical. One method of using a dispersion includes the formation of an electroactive film via deposition of a coating composition.

The dispersions discussed above are used to form a coating composition. A coating composition as utilized herein includes a dispersion, at least one organic binder material, and at least one solvent. A coating composition can be coated onto a substrate to form a nanoparticle based thin film.

In one embodiment, a coating composition that can be utilized includes from 5 wt-% to 25 wt-% of the electroactive chemical bound nanoparticle dispersion. In an embodiment where screen printing is utilized, a coating composition includes from 10 wt-% to 20 wt-% of the electroactive chemical bound nanoparticle dispersion.

A coating composition also includes at least one organic binder material. Organic binder materials are materials that can function as a viscosity modifier, have film forming properties, can add mechanical strength to films that are formed therewith, or some combination thereof. Generally, the at least one organic binder has a minimal solubility in polar solvents, and/or high boiling point solvents. Generally, the at least one organic binder material is compatible with other solvents in the coating composition. Also, the at least one organic binder is compatible with the dispersion so that a homogenous solution is created and maintained when combined with the dispersion. In situations where the coating composition is to be used to create one layer of a multilayered device, it is generally desirable that the organic binder not be soluble in other materials that it may come in contact with. A specific example of this includes the use of the coating composition in fabricating a portion of an electrochromic device or article. In such an example, the coating composition could be used to fabricate an electroactive layer of an electrochromic article for example. In such a case, it would be desirable if the organic binder material were insoluble in the electrolyte with which the electroactive layer may be in contact with.

In one embodiment, organic binder materials that are utilized include high molecular weight polymers. Exemplary materials include, but are not limited to polyethylene oxide (PEO), polyvinyl alcohol (PVA), or polyacrylic acid (PAA). In one embodiment, the organic binder is an alkyl cellulose ether. Examples of alkyl cellulose ethers include, but are not limited to methyl cellulose, hydroxypropyl methyl cellulose and derivatives of hydroxyethyl cellulose. In one embodiment, a methyl cellulose ether is utilized. Suitable methyl cellulose ethers are commercially available from Dow Chemical (Midland Mich.), specific examples of methyl cellulose ethers that can be utilized include METHOCEL E4M from Dow Chemical.

In one embodiment, the at least one organic binder is present in the coating composition from 0.5 wt-% to 2.0 wt-%. In another embodiment, the at least one organic binder is present in the coating composition from 1 wt-% to 2.0 wt-%. In yet another embodiment the at least one organic binder is present in the coating composition from 1 wt-% to 1.5 wt-%.

A coating composition also includes at least one solvent. The at least one solvent generally functions to mix the dispersion and the organic binder. It can also function to allow the coating composition to be coated onto the substrate. In one embodiment therefore, any solvent that can accomplish this function can therefore be included in a coating composition. In another embodiment, there is at least one solvent in the coating composition that can function to control the rate at which the coating composition dries once it is applied to a surface. In such an embodiment it can be beneficial to include at least one solvent that has a high boiling point and low vapor pressure. In one embodiment there is at least one solvent in the coating composition that is a polar solvent. In one embodiment, there is at least one solvent in the coating composition that is compatible with an aqueous dispersion.

In one embodiment, the at least one solvent is water. In another embodiment, water and a second organic solvent are both utilized. In one embodiment, the second solvent is a glycol ether. In one embodiment, the second solvent is ethylene glycol ether; propylene glycol ether; N-methylpyrrolidone; butyrolactone; alcohols, such as ethyl, isopropyl, sec-butyl, n-butyl, methyl; or combinations thereof. One exemplary glycol ether that can be used as the second solvent includes diethylene glycol monoethylether.

In one embodiment, the at least one solvent is present in the coating composition from 75 wt-% to 95 wt-%. In an embodiment where screen printing is utilized, the at least one solvent is present in the coating composition from 80 wt-% to 90 wt-%. In another embodiment where screen printing is utilized, the at least one solvent is present in the coating composition from 83 wt-% to 89 wt-%. In one embodiment, a coating composition utilizes both water and an organic solvent. In such embodiments, the water can be present at 40 wt-% to 50 wt-%, at 44 wt-% to 50 wt-% or at 47 wt-% to 50 wt-%. In such embodiments, the water can be present at 35 wt-% to 45 wt-%, at 37 wt-% to 42 wt-%, or at 39 wt-% to 40 wt-%.

Coating compositions that can be used to form nanoparticle thin film layers can also optionally include one or more redox promoters. Examples of redox promoters include, but are not limited to, ferrocene, and derivatives thereof. In one embodiment, from 0.01 wt-% to 1 wt-% of a redox promoter is utilized in a coating composition. In another embodiment, from 0.02 wt-0% to 0.07 wt-% of a redox promoter is utilized in a coating composition. In yet another embodiment, from 0.04 wt-% to 0.06 wt-% of a redox promoter is utilized in a coating composition.

Coating compositions that can be utilized to form nanoparticle thin film layers can also optionally include other components. Such components would be known to those of skill in the art, having read this specification, and can include for example, pH modifying additives, antifoaming agents, and wetting agents. In one embodiment, a pH modifying additive is utilized to increase the pH of the coating composition. An example of such an additive includes ammonia (NH₄OH). It may also be necessary in some coating compositions to decrease the pH of the coating composition, appropriate acids can be utilized in such instances. In one embodiment, an antifoaming agent is utilized. An example of such an additive includes Dow Corning additive 71 (Dow Corning, Midland Mich.). In one embodiment, a wetting agent is utilized. An example of such an additive includes Dow Corning additive 57 (Dow Corning, Midland Mich.).

Coating compositions that are utilized to form nanoparticle thin film layers can be applied to substrates via any coating method known to those of skill in the art. Generally, coating methods that can produce substantially uniform coatings are utilized. Examples of such methods include, but are not limited to, knife coating, screen printing, extrusion coating, gravure coating, and reverse gravure coating. In one embodiment, screen printing is utilized. Screen printing, gravure coating, and reverse gravure coating can all be advantageous because they can afford the ability to deposit the coating composition in a specific pattern on the substrate.

Coating compositions that can be utilized are generally formulated to have a viscosity of less than 100 Pa·sec. In one embodiment, a coating composition that is utilized has a viscosity from 1 pa·sec to 100 Pa·sec. Coating compositions that are utilized are also formulated to have greater than 85 wt-% nanoparticles in a dried electroactive layer. In another embodiment, the coating composition is formulated to have greater than 90 wt-% nanoparticles in a dried electroactive layer. These amounts of nanoparticles provide electroactive layers with good connectivity between particles, which provides good electrical conductivity and are also better able to withstand swelling by the electrolyte layer, which leads to better device stability.

The electroactive layer that is formed from a coating composition is generally a high porosity layer. This enables the electrolyte to penetrate throughout the regions where the electroactive chemical is bound. In one embodiment, the electroactive layer has a porosity of at least 40%. In one embodiment, the electroactive layer has a porosity of at least 50%. In another embodiment the electroactive layer has a porosity of at least 60%. In one embodiment, the average pore size in an electroactive layer is at least 5 nm. In another embodiment, the average pore size in an electroactive layer is at least 10 nm. Generally the electroactive layer functions to conduct electrons or holes through the porous portions of the nanoparticle structure to the electroactive chemical bound thereon so it can be electrically modified (i.e. reduced or oxidized for example).

The electroactive layers are generally formed on a substrate. The type of substrate that will be used will depend at least in part on the final application and purpose of the device that is being fabricated. In one embodiment, the substrate can be transparent. The substrate can be either rigid or flexible. Embodiments provide the advantage of utilizing low drying temperatures which allows plastic substrates to be utilized. Examples of substrates include but are not limited to glass, polyethylene terephthalates (PETs), polyimides, polyethylene naphthalates (PENs), polycarbonate, poly (ether etherketone) (PEEK), poly (ether sulfone) (PES), polyarylates (PAR), and polycyclic olefin (PCO). The substrate can also be a component of another device or the surface of another device or structure.

Coating compositions can be used to form the nanoparticle thin film layer via application to a substrate via any coating method known to those of skill in the art. Generally, coating methods that can produce substantially uniform coatings are utilized. Examples of such methods include, but are not limited to, knife coating, screen printing, extrusion coating, and reverse gravure coating. In one embodiment, screen printing is utilized. Screen printing, gravure coating, and reverse gravure coating can all be advantageous because they can afford the ability to deposit the coating composition in a specific pattern on the substrate.

### Experimental Materials

P25 TiO₂ powder was obtained from Degussa (Dusseldorf, Germany).

Modified viologen (1,1′-bis(2-phosphonoethyl)-4,4′-bipyridinium dichloride), was synthesized by adding 4,4′-bipyridine (4.4 g) and diethyl-2-bromoehtyl phosphonate (15.0 g) to water (75 mL), and refluxing the reaction mixture for 72 hours. After the reaction mixture was allowed to cool, concentrated hydrochloric acid (50%, 75 mL) was added and the mixture was refluxed for another 24 hours. The product was recovered by concentrating the reaction mixture to 50 mL, adding 200 mL 2-propanol dropwise, and stirring the mixture, on ice, for an hour, followed by filtering. The white crystalline product was washed with cold 2-propanol and air dried to give the redox chromophore 1,1′-bis(2-phosphonoethyl)-4,4′-bipyridinium dichloride.

### EXAMPLE 1

### Preparation of Dispersion Solution

Titanium dioxide nanopowder, P25 from Degussa was premixed using a T 25 ULTRA-TURRAX® Rotor-Stator high-shear mixer (IKA® Works, Inc., Wilmington, N.C.) with an aqueous solution of modified viologen (prepared as given above) at 1 millimolar (mM), 5 mM, 10 mM, and 20 mM. The percent solid in all of the dispersions was about 30% wt. The mixture was further dispersed by the use of a microfluidizer® with serial 250 μm and 85 μm interaction chambers (Microfluidics, Newton, Mass.) operated at about 30,000 psi for up to 8 passes.

The particle size of the dispersions was measured by a LA-910 Laser Scattering Particle Size Distribution Analyzer (Horiba Instruments, Inc., Irvine, Calif.) and data is presented as volume average. The measured mean particle size as a function of the number of microfluidizing passes and the viologen concentrations is shown in the FIGURE.

Thus, embodiments of nanoparticle based thin films are disclosed. One skilled in the art will appreciate that the present invention can be practiced with embodiments other than those disclosed. The disclosed embodiments are presented for purposes of illustration and not limitation, and the present invention is limited only by the claims that follow.

What is claimed is:

1. A dispersion comprising:
nanoparticles having an average diameter from 5 nm to 50 nm; and
at least one electroactive chemical,
wherein the electroactive chemical binds to the surface of the nanoparticles, the dispersion includes agglomerates of the electroactive chemical bound nanoparticles, and a majority of the agglomerates have an average diameter that is not greater than 1 micrometer.

2. The dispersion according to claim 1, wherein the nanoparticles comprise nanoparticles having at least two different average particle sizes.

3. The dispersion according to claim 1, wherein the nanoparticles are a semiconducting metal oxide.

4. The dispersion according to claim 3, wherein the semiconducting metal oxide is titanium dioxide.

5. The dispersion according to claim 1, wherein the semiconducting particles are present at about 50 wt % or less.

6. The dispersion according to claim 1, wherein the electroactive chemical is viologen, ruthenium(II) complexes, polyanilines, polypyridyl complexes, and derivatives thereof.

7. The dispersion according to claim 1, wherein the electroactive chemical is present at about 1 mM to about 100 mM.

8. The dispersion according to claim 1, wherein a majority of the agglomerates have diameters that are less than 500 nanometers.

9. The dispersion according to claim 1, wherein the dispersion is stable for at least one month.

10. A coating composition comprising:
a dispersion comprising:
nanoparticles having an average diameter from 5 nm to 50 nm; and
at least one electroactive chemical,
wherein the electroactive chemical binds to the surface of the nanoparticles, the dispersion includes agglomerates of the electroactive chemical bound nanoparticles, and a majority of the agglomerates have an average diameter that is not greater than 1 micrometer
at least one organic binder material; and
at least one solvent,
wherein the composition has a viscosity of less than 100 Pa·sec.

11. The composition according to claim 10, wherein the electroactive chemical bound nanoparticles are present from about 5 wt % to 25 wt %.

12. The composition according to claim 10, wherein the at least one organic binder material is a high molecular weight polymer that is minimally soluble in a polar solvent.

13. The composition according to claim 10, wherein the at least one organic binder material is methyl cellulose ether.

14. The composition according to claim 10, wherein the at least one solvent is a high boiling point solvent.

15. An article comprising:
a substrate; and
a nanoparticle thin film comprising:
nanoparticles having an average size from 5 nm to 50 nm;
at least one electroactive chemical, wherein the electroactive chemical binds to the surface of the nanoparticles; and
at least one organic binder material.

16. The article according to claim 15, wherein the nanoparticle thin film comprises at least 85 wt-% nanoparticles.

17. The article according to claim 15, wherein the nanoparticle thin film comprises at least 90 wt-% nanoparticles.

18. The article according to claim 15, wherein the nanoparticle thin film has a porosity of at least 50%.

19. The article according to claim 15, wherein the nanoparticle thin film has a porosity of at least 60%.

20. The article according to claim 15, wherein the nanoparticle thin film has an average pore size of at least 5 nm.

21. The article according to claim 15 further comprising a conductive layer positioned between the substrate and the nanoparticle thin film.
